(19) United States
(12) Patent Application Publication
(10) Pub. No.: US 2019/0291699 A1
(43) Pub. Date: Sep. 26, 2019

(54) VEHICLE PURIFICATION DEVICE, VEHICLE PURIFICATION METHOD, AND STORAGE MEDIUM

(71) Applicant: HONDA MOTOR CO., LTD., Tokyo (JP)

(72) Inventors: Makoto Nakatsuka, Wako-shi (JP); Nobuyuki Watanabe, Wako-shi (JP); Seiichi Yamamoto, Tokyo (JP); Yuki Motegi, Tokyo (JP)

(21) Appl. No.: 16/288,130

(22) Filed: Feb. 28, 2019

(30) Foreign Application Priority Data
Mar. 26, 2018 (JP) 2018-058717

(51) Int. Cl. B60S 3/04; B08B 3/02; G05D 1/02; G06T 7/00

(52) U.S. Cl. CPC B60S 3/04; B08B 3/02; G05D 1/0225; G06K 9/00791; G06T 7/0002; G05D 2201/0213; G06T 2207/30252; G05D 1/0223

(57) ABSTRACT

A vehicle purification device includes: a determiner (45, 300) configured to determine a state of a vehicle; a necessity determiner configured to determine whether purification of the vehicle is necessary according to the state of the vehicle determined by the determiner; a possibility determiner configured to determine that the purification of the vehicle is possible using equipment of the vehicle when the necessity determiner determines that the purification of the vehicle is necessary; and a device controller (190) configured to perform a predetermined operation so that the purification is performed by another unit different from the equipment of the vehicle when the possibility determiner determines that the purification of the vehicle is not possible.

### CROSS-REFERENCE TO RELATED APPLICATION

This application claims priority to and benefit of Japanese Patent Application No. 2018-058717, filed on Mar. 26, 2018, which is hereby incorporated by reference in its entirety.

### BACKGROUND

### Field of the Invention

The present invention relates to a vehicle purification device, a vehicle purification method, and a storage medium.

### Description of Related Art

In the related art, a technology for sterilizing bacteria in the interior of a vehicle using an air conditioner included in the vehicle is disclosed (for example, see Japanese Unexamined Patent Application, First Publication No. 2009-248715).

### SUMMARY

In recent years, studies of joint use of vehicles have been carried out. Dirtiness easily occurs in jointly used vehicles. However, in the technologies of the related art, purification of vehicles in accordance with the extent of dirtiness has not been considered.

The present invention is devised in view of such circumstances and one object of the present invention is to provide a vehicle purification device, a vehicle purification method, and a storage medium capable of performing an action for purifying a vehicle even when the vehicle becomes dirty to the extent that countermeasures by equipment of the vehicle are insufficient.

The vehicle purification device, the vehicle purification method, and the storage medium according to aspects of the present invention adopt the following configurations.

(1) According to an aspect of the present invention, there is provided a vehicle purification device including: a determiner configured to determine a state of a vehicle; a necessity determiner configured to determine whether purification of the vehicle is necessary according to the state of the vehicle determined by the determiner; a possibility determiner configured to determine whether the purification of the vehicle is possible using equipment of the vehicle when the necessity determiner determines that the purification of the vehicle is necessary; and a device controller configured to perform a predetermined operation so that the purification is performed by another unit different from the equipment of the vehicle when the possibility determiner determines that the purification of the vehicle is not possible.

(2) In the foregoing (1) aspect, the predetermined operation may be guidance to a cleaning place in which the purification of the vehicle is possible. The vehicle purification device may further include: a recognizer configured to recognize a surrounding situation of the vehicle; and a driving controller configured to control one or both of steering and acceleration or deceleration of the vehicle according to a recognition result of the recognizer. The device controller may control the driving controller such that the vehicle travels to the cleaning place when the possibility determiner determines that the purification is not possible using the equipment.

(3) In the foregoing (1) or (2) aspect, the determiner may include an imaging device. The necessity determiner may determine whether the purification of the vehicle is necessary according to an image captured by the imaging device.

(4) In the foregoing (1) to (3) aspects, the necessity determiner may determine whether the purification of the vehicle is necessary further according to action history information indicating a history of movement of the vehicle.

(5) In the foregoing (1) to (4) aspects, the necessity determiner may determine whether the purification of the vehicle is necessary further according to a surrounding environment of the vehicle.

(6) In the foregoing (1) to (5) aspects, the equipment may include a spraying device that is configured to spray a detergent purifying an interior of the vehicle. The predetermined operation may be the spraying of the detergent by the spraying device.

(7) In the foregoing (6) aspect, the device controller may cause the spraying device to spray the detergent within a predetermined time after an occupant gets out of the vehicle.

(8) According to another aspect of the present invention, there is provided a vehicle purification method of causing a computer to determine a state of a vehicle; determine whether purification of the vehicle is necessary according to the determined state of the vehicle; determine whether the purification of the vehicle is possible using equipment of the vehicle when the purification of the vehicle is determined to be necessary; and perform a predetermined operation so that the purification is performed by another unit different from the equipment of the vehicle when the purification of the vehicle is determined not to be possible.

(9) According to still another aspect of the present invention, there is provided a storage medium causing a computer to determine a state of a vehicle; determine whether purification of the vehicle is necessary according to the determined state of the vehicle; determine whether the purification of the vehicle is possible using equipment of the vehicle when the purification of the vehicle is determined to be necessary; and perform a predetermined operation so that the purification is performed by another unit different from the equipment of the vehicle when the purification of the vehicle is determined not to be possible.

According to (1) to (9), it is possible to clean a vehicle when the vehicle becomes dirty.

According to (2), it is possible to take countermeasures against dirtiness which may not be cleaned unless a vehicle is in a cleaning place.

According to (4) and (5), a vehicle can be cleaned only in appropriate situations, and it is possible to omit unnecessary operations and contribute to energy saving.

According to (7), it is possible to prevent an unfavorable circumstance such as proliferation of viruses due to neglected dirtiness.

### BRIEF DESCRIPTION OF THE DRAWINGS

FIG. 1 is a diagram showing a configuration of a vehicle control device according to a first embodiment.

FIG. 2 is a diagram showing an example of content of cleaning facility information.

FIG. 3 is a diagram showing a configuration of functions of a first controller and a second controller according to the first embodiment.

FIG. 4 is a diagram showing an example of an installation position of an interior camera.

FIG. 5 is a flowchart showing an example of a process of an automatic driving control device.

FIG. 6 is a diagram showing an example of a configuration of a vehicle control device according to a second embodiment.

FIG. 7 is a diagram showing examples of installation positions of a seat cover actuator and a mat actuator.

FIG. 8 is a diagram showing an example of the exterior of a power window device.

FIG. 9 is a diagram showing an example of content of action history information.

FIG. 10 is a diagram showing an example of a hardware configuration of the automatic driving control device according to the embodiment.

### DESCRIPTION OF EMBODIMENTS

Hereinafter, embodiments of a vehicle purification device, a vehicle purification method, and a storage medium according to the present invention will be described with reference to the drawings.

### First Embodiment

### [Overall Configuration]

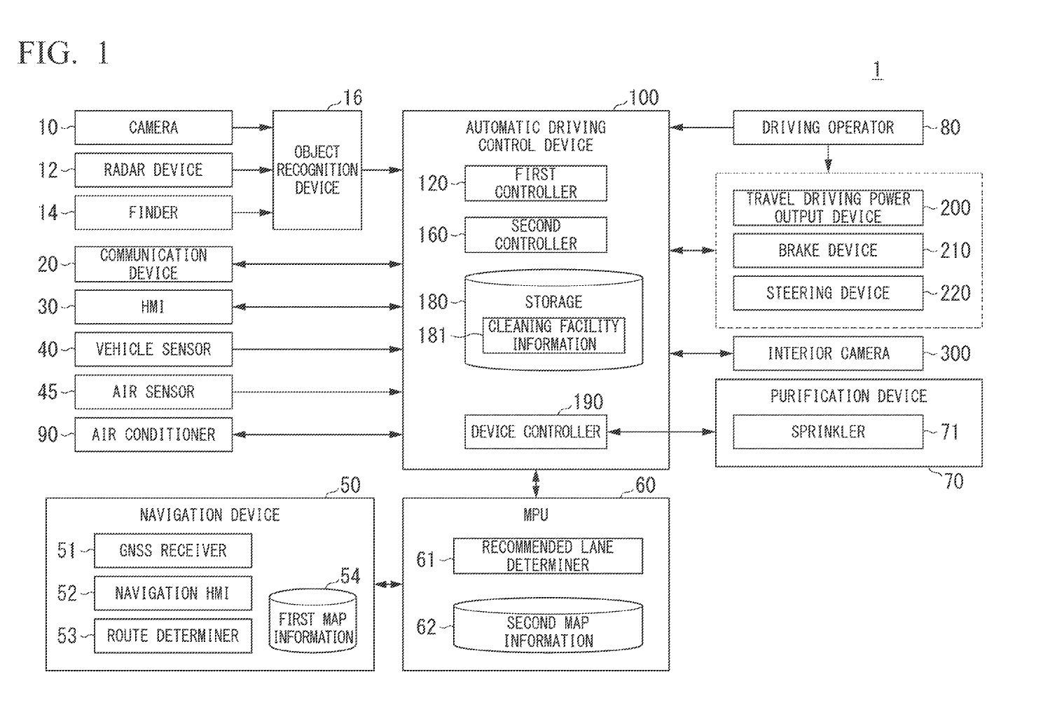

FIG. 1 is a diagram showing a configuration of a vehicle control device 1 according to a first embodiment. A vehicle in which a vehicle control device 1 is mounted (hereinafter referred to as an own vehicle M) is, for example, a vehicle such as a two-wheeled vehicle, a three-wheeled vehicle, or a four-wheeled vehicle. A driving source of the vehicle includes an internal combustion engine such as a diesel engine or a gasoline engine, an electric motor, and a combination thereof. The electric motor operates using power generated by a power generator connected to the internal combustion engine or power discharged from a secondary cell or a fuel cell. In the embodiment, for example, the own vehicle M will be described as an automatically driven vehicle, but the present invention is not limited thereto. The own vehicle M may be manually driven by an operation of an occupant.

The vehicle control device 1 includes, for example, a camera 10, a radar device 12, a finder 14, an object recognition device 16, a communication device 20, a human machine interference (HMI) 30, a vehicle sensor 40, an air sensor 45, a navigation device 50, a map positioning unit (MPU) 60, a purification device 70, a driving operator 80, an air conditioner 90, an automatic driving control device 100, a travel driving power output device 200, a brake device 210, a steering device 220, and an interior camera 300. The devices and units are connected to each other via a multiplex communication line such as a controller area network (CAN) communication line, a serial communication line, and a wireless communication network. The configuration shown in FIG. 1 is merely exemplary, a part of the configuration may be omitted, and another configuration may be further added.

The camera 10 is, for example, a digital camera that uses a solid-state image sensor such as a charged coupled device (CCD) or a complementary metal oxide semiconductor (CMOS). The camera 10 is mounted on any portion of the own vehicle M. In the case of front imaging, the camera 10 is mounted on an upper portion of a front windshield, a rear surface of a rearview mirror, or the like. For example, the camera 10 repeatedly images the periphery of the own vehicle M periodically. The camera 10 may be a stereo camera.

The radar device 12 radiates radio waves such as millimeter waves to the periphery of the own vehicle M and determines radio waves (reflected waves) reflected from an object to determine at least a position (a distance and an azimuth) of the object. The radar device 12 is mounted on any portion of the own vehicle M. The radar device 12 may determine a position and a velocity of an object in conformity with a frequency modulated continuous wave (FM-CW) scheme.

The finder 14 is a light determination and ranging (LIDAR) device. The finder 14 emits light to the periphery of the own vehicle M and measures scattered light. The finder 14 determines a distance to a target according to a time from light emission and light reception. The emitted light is, for example, a pulsed laser beam. The finder 14 is mounted on any portion of the own vehicle M.

The object recognition device 16 performs a sensor fusion process on determination results of some or all of the camera 10, the radar device 12, and the finder 14 and recognizes a position, a kind, a speed, and the like of an object. The object recognition device 16 outputs a recognition result to the automatic driving control device 100. The object recognition device 16 may output the determination results of the camera 10, the radar device 12, and the finder 14 without change to the automatic driving control device 100. The object recognition device 16 may be omitted from the vehicle control device 1.

The communication device 20 communicates with other vehicles around the own vehicle M using, for example, a cellular network, a Wi-Fi network, Bluetooth (registered trademark), dedicated short range communication (DSRC), or the like or communicate with various server devices via wireless base stations.

The HMI 30 suggests various kinds of information to occupants of the own vehicle M and receives input manipulations by the occupants. The HMI 30 includes various display devices, speakers, buzzers, touch panels, switches, and keys.

The vehicle sensor 40 includes a vehicle speed sensor that determines a speed of the own vehicle M, an acceleration sensor that determines acceleration, a yaw rate sensor that determines an angular velocity around a vertical axis, and an azimuth sensor that determines a direction of the own vehicle M.

The air sensor 45 determines pollutants which are contained in the air in the interior of the vehicle and are determination targets of the sensor. For example, at least one of an optical sensor that determines dust, pollen, or particulate matter (PM 2.5 or the like), a sulfur oxide (SOx) sensor, a nitrogen oxide (NOx) sensor, a photochemical oxidant sensor, and an ammonia sensor is used as the air sensor 45. The air sensor 45 is installed on the ceiling of the interior middle of the vehicle, near a center console, or a gas passage of the air conditioner 90 which is an air conditioner of the own vehicle M. A determination result of the air sensor 45 is output to the automatic driving control device 100.

The navigation device 50 includes, for example, a global navigation satellite system (GNSS) receiver 51, a navigation HMI 52, and a route determiner 53. The navigation device 50 retains first map information 54 in a storage device such as a hard disk drive (HDD) or a flash memory.

The GNSS receiver 51 specifies a position of the own vehicle M according to signals received from GNSS satellites. The position of the own vehicle M may be specified or complemented by an inertial navigation system (INS) using an output of the vehicle sensor 40.

The navigation HMI 52 includes a display device, a speaker, a touch panel, and a key. The navigation HMI 52 may be partially or entirely common to the above-described HMI 30.

The route determiner 53 decides, for example, a route from a position of the own vehicle M specified by the GNSS receiver 51 (or an input any position) to a destination place input by an occupant using the navigation HMI 52 (hereinafter referred to as a map route) with reference to the first map information 54. The first map information 54 is, for example, information in which a road model is expressed by links indicating roads and nodes connected by the links. The first map information 54 may include curvatures of roads and point of interest (POI) information. The map route is output to the MPU 60.

The navigation device 50 may perform a route guide using the navigation HMI 52 according to a map route. The navigation device 50 may be realized by, for example, a function of a terminal device such as a smartphone or a tablet terminal possessed by the occupant. The navigation device 50 may transmit a current position and a destination place to a navigation server via the communication device 20 to acquire the same route as a map route from the navigation server.

The MPU 60 includes, for example, a recommended lane determiner 61 and retains second map information 62 in a storage device such as an HDD or a flash memory. The recommended lane determiner 61 divides a map route provided from the navigation device 50 into a plurality of blocks (for example, divides the map route in a vehicle movement direction for each 100 [m]) and decides a recommendation lane for each block with reference to the second map information 62. The recommended lane determiner 61 decides in which lane the own vehicle M travels from the left. When there is a branching spot on a map route, the recommended lane determiner 61 decides a recommendation lane so that the own vehicle M can travel along a reasonable route for traveling to a branding destination.

The second map information 62 is map information with higher precision than the first map information 54. The second map information 62 includes, for example, information regarding the middles of lanes or information regarding boundaries of lanes and information regarding kinds of lanes. The second map information 62 includes road information, traffic regulation information, address information (address and postal number), facility information, and telephone number information. The second map information 62 may frequently be updated when the communication device 20 communicates with another device.

The purification device 70 performs interior purification in the own vehicle M. The purification device 70 includes, for example, a sprinkler 71. For example, the sprinkler 71 is installed on a ceiling of the interior of the own vehicle M and sprays a detergent to floor surfaces, the surfaces of seats, and the like of the own vehicle M. The detergent is, for example, a substance used for interior deodorization and sterilization and removal or the like of a specific substance and is specifically a vapor, an alcohol, a hypochlorous acid, or the like. When the purification device 70 sprays the detergent in the vehicle, interior deodorization and sterilization of the interior can be performed or dust, pollen, or PM 2.5 in the interior can be adsorbed with the detergent to be removed. The sprinkler 71 may be configured to spray the detergent to the gas passage of the air conditioner 90 of the own vehicle M and spread the detergent to the interior of the vehicle with air conditioning. In the following description, the interior of the own vehicle M is simply referred to as an “interior.” The sprinkler 71 is an example of a “spraying device.”

The driving operator 80 includes, for example, an accelerator pedal, a brake pedal, a shift lever, a steering wheel, a steering variant, a joystick, and other manipulators. A sensor that determines whether there is a manipulation amount or a manipulation is mounted on the driving operator 80. A determination result is output to the automatic driving control device 100 or some or all of the travel driving power output device 200, the brake device 210, and the steering device 220.

The air conditioner 90 adjusts an environment of the interior by adjusting an air state of the interior. An operation of the air conditioner 90 is controlled by an air conditioner ECU receiving an operation of an occupant and is also controlled directly via the air conditioner ECU by the automatic driving control device 100. The air conditioner 90 includes a heater in the following description, but the heater may be installed apart from the air conditioner 90.

The automatic driving control device 100 includes, for example, a first controller 120, a second controller 160, a storage 180, and a device controller 190. Each of the first controller 120, the second controller 160, and the device controller 190 is realized, for example, by causing a processor such as a central processing unit (CPU) to execute a storage medium (software). Some of all of these constituent elements may be realized by hardware (circuit unit including a circuitry) such as a large scale integration (LSI), an application specific integrated circuit (ASIC), a field-programmable gate array (FPGA), or a graphics processing unit (GPU) or may be realized in cooperation of software and hardware. The storage medium may be stored in advance in the storage 180 of the automatic driving control device 100 or may be stored in a removable storage medium such as a DVD or a CD-ROM to be installed in the storage 180 when the storage medium is mounted on the drive device.

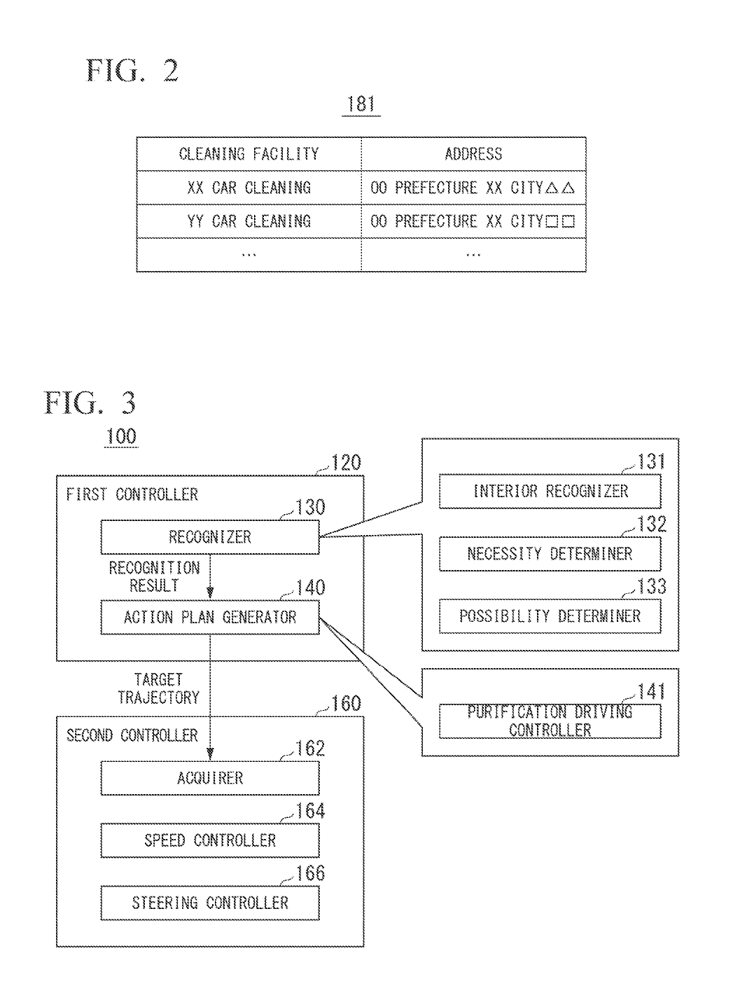

The storage 180 is realized by, for example, a HDD, a flash memory, an electrically erasable programmable read only memory (EEPROM), a read only memory (ROM), or a random access memory (RAM). The storage 180 includes, for example, a storage medium read and executed by a processor. The storage 180 stores cleaning facility information 181. FIG. 2 is a diagram showing an example of content of the cleaning facility information 181. The cleaning facility information 181 is information indicating the position of a cleaning facility (for example, a car cleaning shop) that purifies the interior.

FIG. 3 is a diagram showing functions of the first controller 120 and the second controller 160 according to the first embodiment. The first controller 120 includes, for example, a recognizer 130 and an action plan generator 140. The recognizer 130 includes an interior recognizer 131, a necessity determiner 132, and a possibility determiner 133. The action plan generator 140 includes, for example, a purification driving controller 141. The first controller 120 concurrently realizes, for example, a function by artificial intelligence (AI) and a function by a pre-given model. For example, an “intersection recognition” function may be realized by concurrently performing recognition of an intersection by deep learning or the like and recognition according to a pre-given condition (there is a sign, a road sign, and the like for which pattern matching is possible) and scoring the both for comprehensive evaluation. In this way, reliability of automatic driving is guaranteed.

The recognizer 130 recognizes surrounding situations of the own vehicle M according to information input from the camera 10, the radar device 12, and the finder 14 via the object recognition device 16. Specifically, the recognizer 130 recognizes situations such as a position, a speed, acceleration, and the like of objects around the own vehicle M. The position of an object is recognized as, for example, a position on absolute coordinates for which a representative point (the center of gravity, a center of a driving shaft, or the like) of the own vehicle M is set as the origin and is used for control. The position of an object may be expressed as a representative point of the center, a corner, or the like of the object or may be represented in an expressed region. A “state” of an object may include acceleration or jerk of the object or an “action state” (for example, whether to change a lane or attempt to change a lane).

For example, the recognizer 130 recognizes a lane (traveling lane) in which the own vehicle M is traveling. For example, the recognizer 130 recognizes a traveling lane by comparing patterns of road mark lines (for example, arrangement of continuous lines and broken lines) obtained from the second map information 62 with patterns of road mark lines around the one vehicle M recognized from images captured by the camera 10. The recognizer 130 may recognize a traveling lane by recognizing runway boundaries (road boundaries) including road mark lines or shoulders, curbstones, median strips, and guardrails without being limited to road mark lines. In this recognition, the position of the own vehicle M acquired from navigation device 50 or a process result by INS may be added. The recognizer 130 recognizes temporary stop lines, obstacles, red signals, toll gates, other road events.

The recognizer 130 recognizes a position or an attitude of the own vehicle M with respect to the traveling lane when the recognizer 130 recognizes the traveling lane. For example, the recognizer 130 may recognize a separation from the middle of a lane of a reference point of the own vehicle M and an angle formed with a line extending along the middle of a lane in the traveling direction of the own vehicle M as a relative position and attitude of the own vehicle M to the traveling lane. Instead of this, the recognizer 130 may recognize a position or the like of the reference point of the own vehicle M with respect to a side end portion (a road mark line or a road boundary) of any traveling lane as the relative position of the own vehicle M to the traveling lane.

The recognizer 130 may derive recognition accuracy through the foregoing recognition process and may output the recognition accuracy as recognition accuracy information to the action plan generator 140. For example, the recognizer 130 generates the recognition accuracy information according to a frequency at which a road mark line can be recognized during a given period. Functions of the interior recognizer 131, the necessity determiner 132, and the possibility determiner 133 included in the recognizer 130 will be described later.

The action plan generator 140 generates a target trajectory in which the own vehicle M travels in future so that the own vehicle can travel in a recommendation lane decided by the recommended lane determiner 61 in principle and automatic driving corresponding to a surrounding situation of the own vehicle M is performed. The target trajectory includes, for example, a speed element. For example, the target trajectory is expressed by sequentially arranging spots (trajectory points) to which the own vehicle M is scheduled to arrive. The trajectory points are spots at which the own vehicle M is scheduled to arrive for each predetermined traveling distance (for example, about several [m]) distance along a road. Apart from this, a target speed and target acceleration are generated as a part of the target trajectory for each predetermined sampling time (for example, about 0 decimal point [sec]). A function of the purification driving controller 141 included in the action plan generator 140 will be described later.

The second controller 160 includes, for example, an acquirer 162, a speed controller 164, and a steering controller 166. The acquirer 162 acquires information regarding the target trajectory generated by the action plan generator 140 and stores the information in a memory (not shown). The speed controller 164 controls the travel driving power output device 200 or the brake device 210 according to the speed element pertaining to the target trajectory stored in the memory. The steering controller 166 controls the steering device 220 in accordance with a curve state of the target trajectory stored in the memory. Processes of the speed controller 164 and the steering controller 166 are realized, for example, by combining feed-forward control and feedback control. For example, the steering controller 166 performs the feed-forward control in accordance with a curvature of a road in front of the own vehicle M and the feedback control according to separation from the target trajectory in combination. A combination of the action plan generator 140 and the second controller 160 is an example of a “driving controller.”

Referring back to FIG. 1, the travel driving power output device 200 outputs a travel driving force (torque) for traveling the vehicle to a driving wheel. The travel driving power output device 200 includes, for example, an internal combustion engine, a combination of an electric motor and a transmission, and an ECU controlling these units. The ECU controls the foregoing configuration in accordance with information input from the second controller 160 or information input from the driving operator 80.

The brake device 210 includes, for example, a brake caliper, a cylinder that transmits a hydraulic pressure to the brake caliper, an electronic motor that generates a hydraulic pressure to the cylinder, and a brake ECU. The brake ECU controls the electric motor in accordance with information input from the second controller 160 or information input from the driving operator 80 such that a brake torque in accordance with a brake operation is output to each wheel. The brake device 210 may include a mechanism that transmits a hydraulic pressure generated in accordance with an operation of the brake pedal included in the driving operator 80 to the cylinder via a master cylinder as a backup. The brake device 210 is not limited to the above-described configuration and may be an electronic control type hydraulic brake device that controls an actuator in accordance with information input from the second controller 160 such that a hydraulic pressure of the master cylinder is transmitted to the cylinder.

The steering device 220 includes, for example, a steering ECU and an electric motor. The electric motor works a force to, for example, a rack and pinion mechanism to change a direction of a steering wheel. The steering ECU drives the electric motor to change the direction of the steering wheel in accordance with information input from the second controller 160 or information input from the driving operator 80.

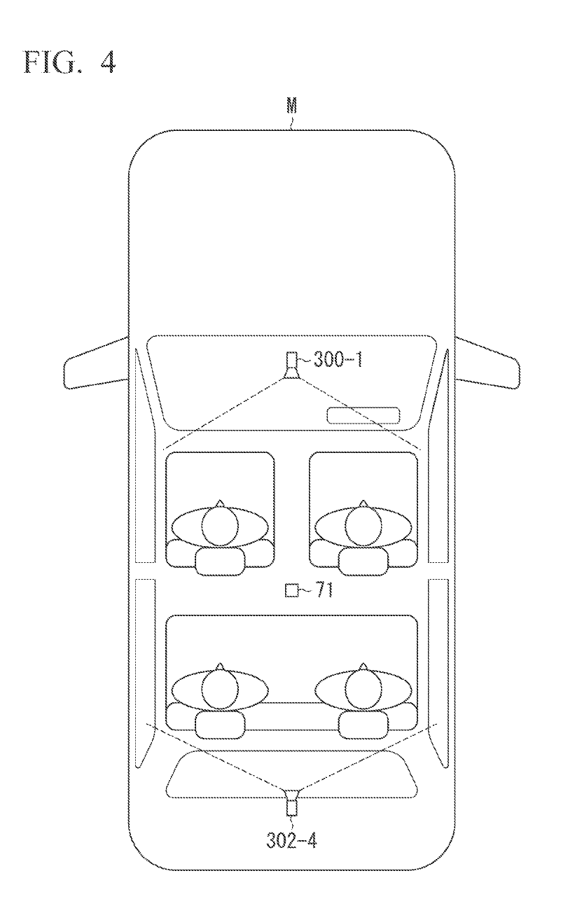

The interior camera 300 images a space in the interior with a seat on which an occupant in the own vehicle M sits or the floor surface of the own vehicle M set as a center. FIG. 4 is a diagram showing an example of an installation position of an interior camera 300. In the own vehicle M, for example, a plurality of interior cameras 300 (shown interior cameras 300-1 and 300-2) are installed. The interior camera 300-1 recognizes the front side of the interior and the interior camera 300-2 recognizes the rear side of the interior. In the following description, when the interior cameras 300-1 and 300-2 are not distinguished from each other, the interior cameras 300-1 and 300-2 are collectively referred to as the interior cameras 300. The number of interior cameras 300 provided in the own vehicle M may be one or two or more, as long as the seats or the floor surface of the own vehicle M can be imaged. For example, the interior cameras 300 are preferably installed at positions at which the detergent of the sprinkler 71 is not attached. The air sensor 45 and the interior camera 300 are examples of a “determiner” and an “imaging device.”

### [Details of Recognizer 130]

Hereinafter, each functional unit included in the recognizer 130 will be described. The interior recognizer 131 recognizes the extent of dirtiness of the interior according to images captured by the interior cameras 300 and a determination result of the air sensor 45. The extent of dirtiness of the interior is, for example, the extent of dirtiness attached to the floor surface or the surfaces of the seats of the own vehicle M or the extent of pollutant in the air of the interior.

The necessity determiner 132 determines whether purification of the interior is necessary according to the extent of dirtiness of the interior recognized by the interior recognizer 131. Specifically, when at least one of the following predetermined conditions (1) to (4) is satisfied, the necessity determiner 132 determines that the purification of the interior is necessary. The predetermined condition (1) is that a sum of the areas of the dirtiness attached to the floor surface or the surfaces of the seats of the own vehicle M is equal to or greater than a predetermined area. The predetermined condition (2) is that the area of the dirtiness attached to the floor surface or the surface of a seat of the own vehicle M is equal to or greater than a predetermined area. The predetermined condition (3) is that the depth of color of the dirtiness attached to the floor surface or the surface of a seat of the own vehicle M is equal to or greater than a predetermined depth. The predetermined condition (4) is that pollutants in the air of the interior are equal to or greater than a predetermined amount.

When the necessity determiner 132 determines that the purification of the interior is necessary, the possibility determiner 133 determines whether the dirtiness of the interior can be purified by the equipment of the own vehicle M. The equipment of the own vehicle M is, for example, the purification device 70 or the air conditioner 90.

For example, when the dirtiness of the interior recognized by the interior recognizer 131 is pollutants in the air of the interior, the possibility determiner 133 determines whether the pollutants can be removed by causing the sprinkler 71 of the purification device 70 to spray the detergent. When it is determined that the pollutants in the air of the interior can be removed by the sprinkler 71, the possibility determiner 133 determines that the dirtiness of the interior can be purified by the equipment of the own vehicle M. When it is determined that the pollutants in the air of the interior may not be removed by the sprinkler 71, the possibility determiner 133 determines that the dirtiness of the interior may not be purified by the equipment of the own vehicle M.

For example, when the dirtiness of the interior recognized by the interior recognizer 131 is dirtiness attached to the floor surface or the surface of a seat of the own vehicle M and the dirtiness is dirtiness (a stain) caused due to spilling of a liquid, the possibility determiner 133 determines whether the stain can be removed by causing the air conditioner 90 to blow air on the stain. When it is determined that the stain can be removed by causing the air conditioner 90 to blow air on it, the possibility determiner 133 determines that the dirtiness of the interior can be purified by the equipment of the own vehicle M. When it is determined that the stain may not be removed by causing the air conditioner 90 to blow air on it, the possibility determiner 133 determines that the dirtiness of the interior may not be purified by the equipment of the own vehicle M.

### [Device Controller 190]

The device controller 190 controls each unit included in the vehicle control device 1 according to a determination result of the possibility determiner 133. Specifically, when the possibility determiner 133 determines that the dirtiness of the interior can be purified by the equipment of the own vehicle M, the device controller 190 purifies the dirtiness of the interior by controlling the purification device 70 or the air conditioner 90. When the possibility determiner 133 determines that the dirtiness of the interior may not be purified by the equipment of the own vehicle M, the device controller 190 instructs the purification driving controller 141 to move the own vehicle M to a cleaning facility indicated by the cleaning facility information 181.

### [Purification Driving Controller 141]

Hereinafter, the purification driving controller 141 will be described. The purification driving controller 141 causes the own vehicle M to move to a cleaning facility according to the instruction of the device controller 190 and the cleaning facility information 181. The own vehicle M is, for example, the own vehicle M for which a contract is executed in advance with a car cleaning shop which is a cleaning facility indicated by the cleaning facility information 181. A staff member of the car cleaning shop purifies the interior of the own vehicle M when the own vehicle M for which a contract has been executed visits the shop. For example, the purification driving controller 141 causes the own vehicle M to move to a cleaning facility closest to the current position among the cleaning facilities indicated by the cleaning facility information 181. In the car cleaning shop, not only the interior of the own vehicle M but also the outer body of the own vehicle M may be purified.

Here, when the purification driving controller 141 causes the own vehicle M to move to the cleaning facility according to a determination result of the possibility determiner 133 and an occupant is in the own vehicle M, the movement to the cleaning facility may obstruct movement of the occupant in some cases. Therefore, in the embodiment, a case in which the purification driving controller 141 causes the own vehicle M to move to a cleaning facility according to a recognition result of the recognizer 130 when no occupant is in the own vehicle M will be described.

### [Process Flow]

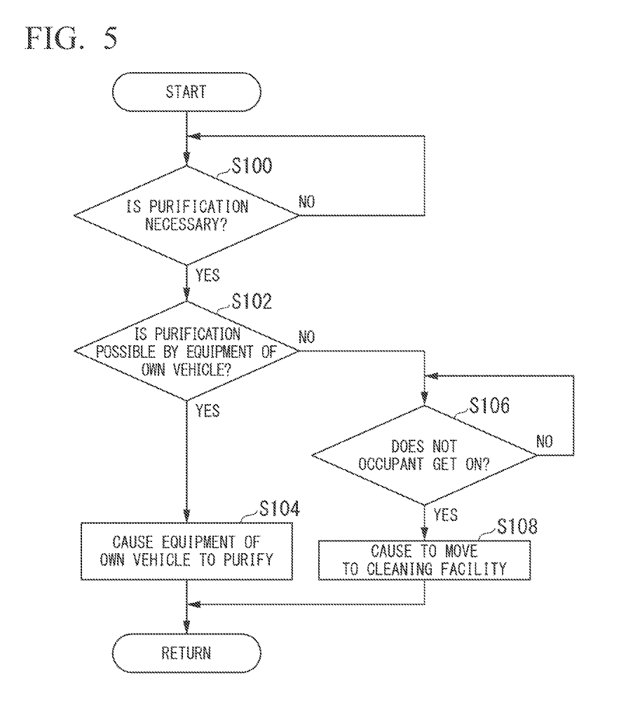

FIG. 5 is a flowchart showing an example of a process of an automatic driving control device 100. A process of the flowchart shown in FIG. 5 is performed at a predetermined time interval. According to a recognition result of the interior recognizer 131, the necessity determiner 132 first determines whether the purification of the interior is necessary (step S100). The process does not proceed to a subsequent process when the necessity determiner 132 determines that the purification of the interior is not necessary. When the necessity determiner 132 determines that the purification of the interior is necessary, the possibility determiner 133 subsequently determines whether the interior can be purified by the equipment included in the own vehicle M (for example, the purification device 70 or the air conditioner 90) (step S102). When the possibility determiner 133 determines that the interior can be purified by the equipment included in the own vehicle M, the device controller 190 controls the purification device 70 or the air conditioner 90 to purify the interior (step S104).

When the necessity determiner 132 determines that the predetermined condition (4) is satisfied and the possibility determiner 133 determines that the purification of the interior is possible, the device controller 190 causes the purification device 70 to spray the detergent in the interior using the sprinkler 71 in step S104. When the necessity determiner 132 determines that the predetermined conditions (1) to (3) are satisfied and the possibility determiner 133 determines that the purification of the interior is possible, the device controller 190 causes the air conditioner 90 to blow air on dirtiness (for example, a stain) recognized by the interior recognizer 131 in step S104.

When the possibility determiner 133 determines that the interior may not be purified by the equipment included in the own vehicle M, the purification driving controller 141 subsequently determines whether an occupant is in the own vehicle M according to a recognition result of the recognizer 130 (the interior recognizer 131) (step S106). Subsequently, the purification driving controller 141 waits without proceeding to the subsequent process when the purification driving controller 141 determines that an occupant is in the own vehicle M (that is, until the occupant exits the own vehicle M) according to the recognition result of the recognizer 130 (step S106). When the purification driving controller 141 determines that no occupant is in the own vehicle M, the purification driving controller 141 subsequently causes the own vehicle M to move to the cleaning facility indicated by the cleaning facility information 181 according to the instruction from the device controller 190 (step S108). The interior of the own vehicle M moved to the cleaning facility in step S108 is cleaned in the car cleaning shop which is the cleaning facility.

### Conclusion of First Embodiment

As described above, the vehicle control device 1 according to the embodiment includes a determiner (in this example, the air sensor 45 and the interior camera 300) configured to determine a state of the vehicle; the necessity determiner 132 configured to determine whether purification of the own vehicle M is necessary according to the state of the own vehicle M (in this example, a state of the interior) determined by the determiner; the possibility determiner 133 configured to determine that the purification of the own vehicle M is possible using equipment of the own vehicle M (for example, the purification device 70 or the air conditioner 90) when the necessity determiner 132 determines that the purification of the own vehicle M is necessary; and the device controller 190 configured to perform a predetermined operation so that the purification is performed by another unit (in this example, a cleaning facility (car cleaning shop)) different from the equipment of the own vehicle M when the possibility determiner 133 determines that the purification of the own vehicle M is not possible. In the vehicle control device 1 according to the embodiment, the predetermined operation is guidance to a cleaning place (in this example, the cleaning facility) in which the purification of the own vehicle M is possible. The vehicle purification device further includes: the recognizer 130 configured to recognize a surrounding situation of the own vehicle M; and a driving controller (in this example, the action plan generator 140 and the second controller 160) configured to control one or both of steering and acceleration or deceleration of the own vehicle M according to a recognition result of the recognizer 130. The device controller 190 controls (instructs) the driving controller such that the own vehicle M travels to the cleaning place when the possibility determiner 133 determines that the purification is not possible using the equipment of the own vehicle M. Thus, the vehicle control device 1 according to the embodiment can purify the own vehicle M when the own vehicle M becomes dirty.

### Second Embodiment

Hereinafter, a second embodiment of the present invention will be described with reference to the drawings. In the first embodiment, the case in which the equipment used to purify the own vehicle M is the purification device 70 and the air conditioner 90 has been described. In the second embodiment, another equipment which is used to purify the own vehicle M is included will be described. The same reference numerals are given to a configuration similar to that of the above-described embodiment and the description thereof will be omitted.

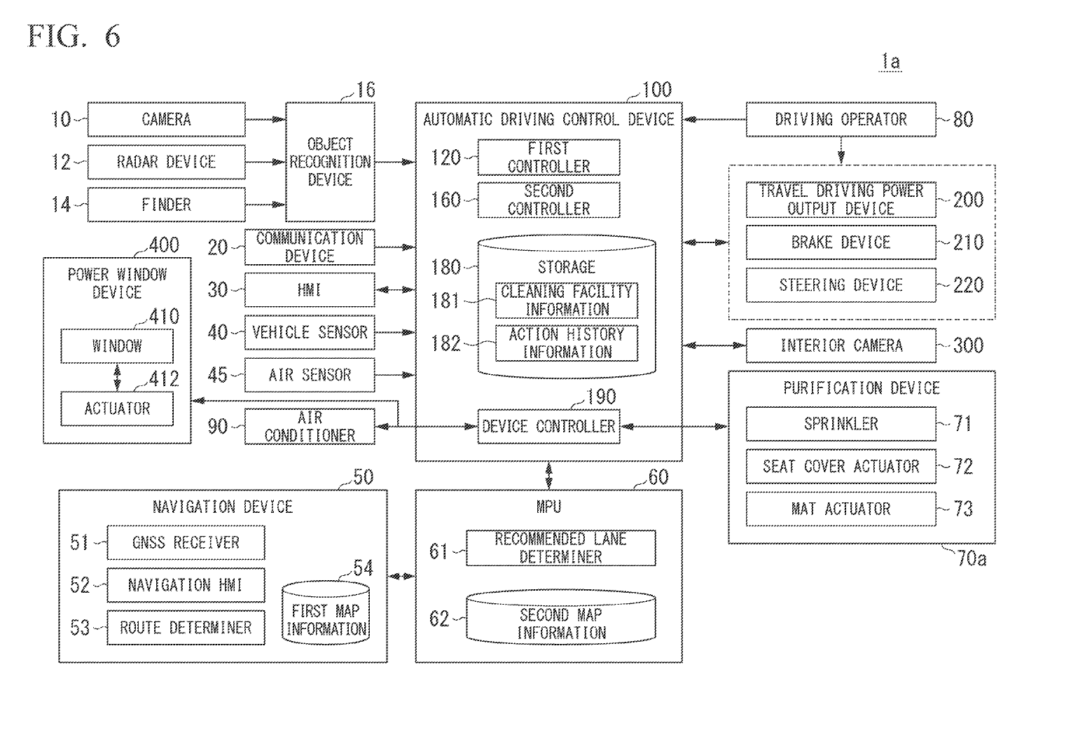

FIG. 6 is a diagram showing an example of a configuration of a vehicle control device 1a according to the second embodiment. The vehicle control device 1a includes a purification device 70a instead of (or in addition to) the purification device 70. The purification device 70a further includes a seat cover actuator 72 and a mat actuator 73 compared to the purification device 70. The vehicle control device 1a further includes a power window device 400 compared to the configuration of the vehicle control device 1. The storage 180 of the vehicle control device 1a further stores action history information 182. Hereinafter, the details of each unit will be described.

### [Seat Cover Actuator 72 and Mat Actuator 73]

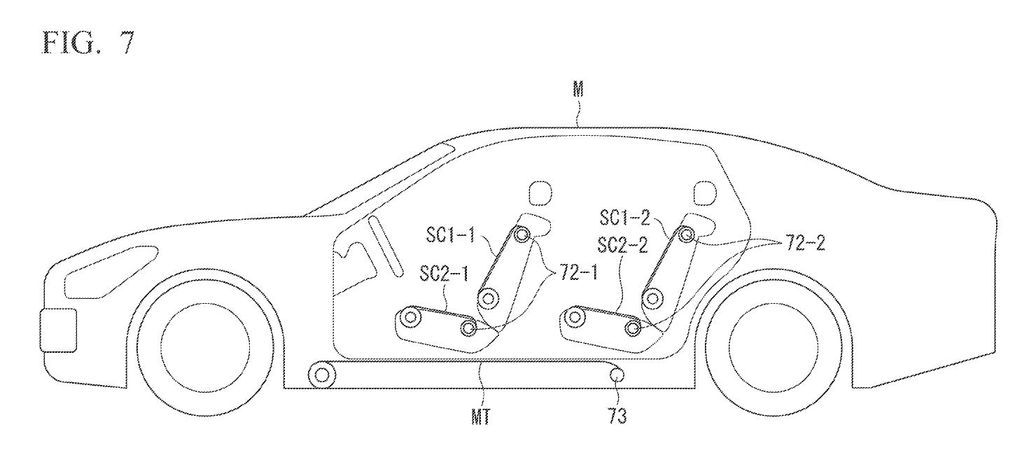

FIG. 7 is a diagram showing examples of installation positions of the seat cover actuator 72 and the mat actuator 73. As shown in FIG. 7, the own vehicle M includes a plurality of seat cover actuators 72 (shown seat cover actuators 72-1 and 72-2) and a mat actuator 73. The seat cover actuator 72-1 is installed in a driver's seat and the seat cover actuator 72-2 is installed in a back seat. In the following description, when the seat cover actuators 72-1 and 72-2 are not distinguished from each other, the seat cover actuators 72-1 and 72-2 are collectively referred to as the seat cover actuators 72. In FIG. 7, to facilitate the description, a case in which two seat cover actuators 72 are included in the own vehicle M will be described. However, the seat cover actuator 72 may be included in each seat included in the own vehicle M. The mat actuator 73 is installed on the floor surface of the own vehicle M.

As shown in FIG. 7, rear surface seats SC1 (shown rear surface seats SC1-1 and SC1-2) or sitting surface seats SC2 (shown sitting surface seats SC2-1 and SC2-2) are realized with long fabrics or the like and parts of the fabrics are exposed to the rear surfaces and sitting surfaces of the seats. The seat cover actuators 72 are realized by, for example, motors and are connected to rolls winding ends of the rear surface seat SC1 and the sitting surface seat SC2. The seat cover actuators 72 is driven according to control of the automatic driving control device 100 and winds the rear surface seat SC1 or the sitting surface seat SC2 by a predetermined length (for example, the length of the rear surface or the sitting surface) from another roll winding the other end of the rear surface seat SC1 or the sitting surface seat SC2 by rotating the connected roll. Thus, the seat cover actuators 72 can exchange the rear surface seat SC1 or the sitting surface seat SC2 from parts of the fabrics exposed until now to parts of new fabrics.

As shown in FIG. 7, a mat MT spread on the floor of the own vehicle M is realized with a long fabric or the like and a part of the fabric is exposed to the floor surface. The mat actuator 73 is realized by, for example, by a motor and is connected to the roll winding the end of the mat MT. The mat actuator 73 is driven according to control of the automatic driving control device 100 and winds the mat MT by a predetermined length (for example, the length of the floor surface) from another roll winding the other end of the mat MT by rotating the connected roll. Thus, the mat actuator 73 can exchange the mat MT from a part of the fabric exposed until now to a part of a new fabric. To make less dirty, the fabric of the rear surface seat SC1, the sitting surface seat SC2, or the mat MT is preferably realized with, for example, a material strong to dirtiness, such as a synthetic fiber.

### [Power Window Device 400]

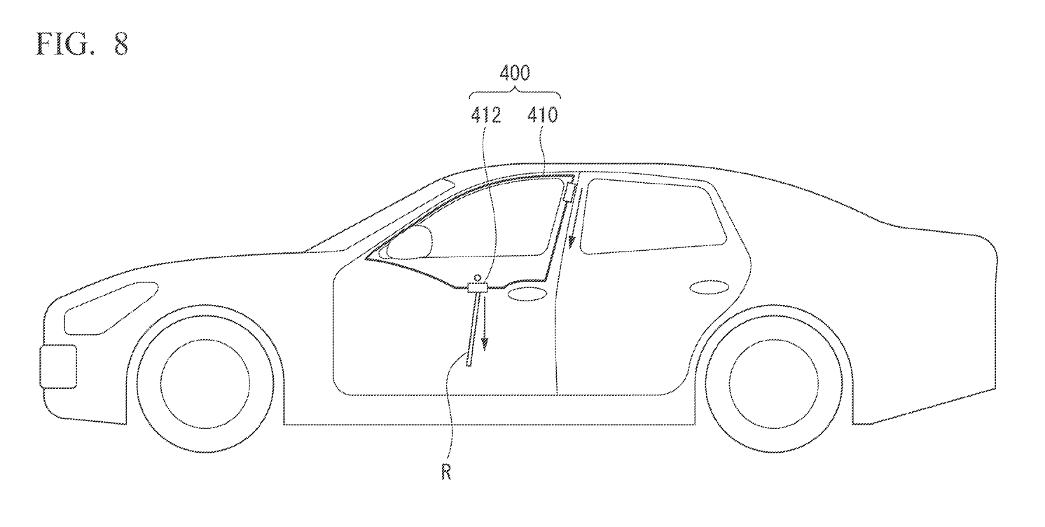

FIG. 8 is a diagram showing an example of the exterior of the power window device 400. As shown in FIG. 8, the power window device 400 includes a window 410 and a actuator 412. The window 410 and the actuator 412 are mutually fixed. The actuator 412 is moved along a rail (a shown rail R) according to control of the automatic driving control device 100 (the device controller 190) so that the window 410 is moved (opened or closed) in the vertical direction.

### [Action History Information 182]

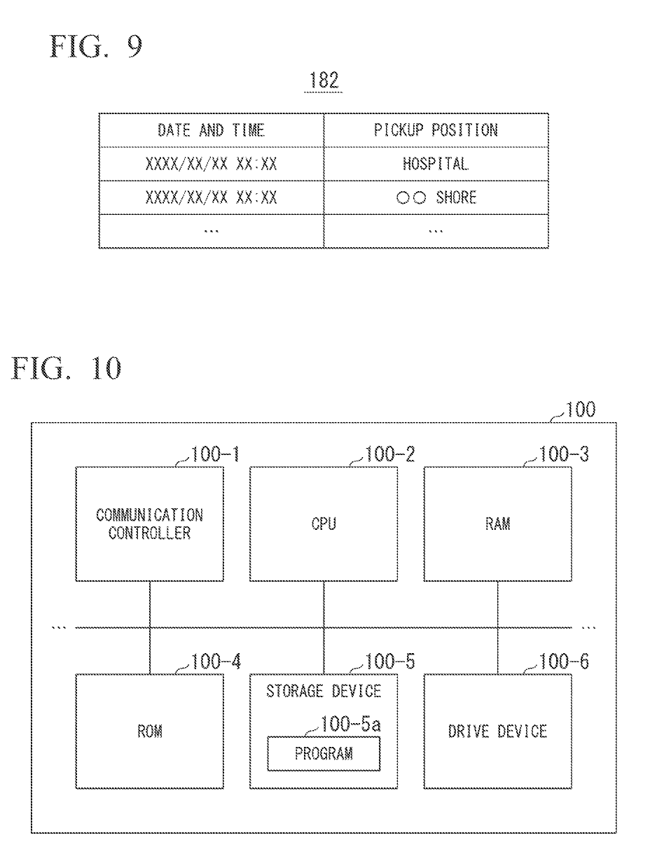

FIG. 9 is a diagram showing an example of content of the action history information 182. The action history information 182 is, for example, information in which a date and time on which an occupant gets on the own vehicle M and a position (shown pickup position) at which an occupant acts (stays) at the date and time are associated with each other. For example, the action history information 182 is set (registered) in advance by a user of the own vehicle M. For example, referring to the action history information 182, the automatic driving control device 100 travels the own vehicle so that the own vehicle arrives at the pickup position indicated by the action history information 182 until the date and time indicted by the action history information 182.

### [Possibility Determiner 133]

As described above, the possibility determiner 133 determines whether the dirtiness of the interior can be purified by the equipment of the own vehicle M when the necessity determiner 132 determines that the purification of the interior is necessary. In the embodiment, the equipment of the own vehicle M is, for example, the purification device 70, the air conditioner 90, or the power window device 400.

For example, when the dirtiness of the interior recognized by the interior recognizer 131 is pollutants in the air of the interior, the possibility determiner 133 determines whether the pollutants can be removed by introducing the outside air accompanied with an operation of the air conditioner 90 or introducing the outside air accompanied with an open state of the window 410 by the power window device 400. When it is determined that the pollutants in the air of the interior can be removed by the sprinkler 71, the possibility determiner 133 determines that the dirtiness of the interior can be purified by the equipment of the own vehicle M. When it is determined that the dirtiness of the interior may not be removed by introducing the outside air, the possibility determiner 133 determines that the dirtiness of the interior may not be purified by the equipment of the own vehicle M.

For example, when the dirtiness of the interior recognized by the interior recognizer 131 is dirtiness attached to the floor surface of the surface of a seat of the own vehicle M, the possibility determiner 133 determines whether the stain can be removed by driving the seat cover actuators 72 or the mat actuator 73. When it is determined that the stain can be removed by driving the seat cover actuators 72 or the mat actuator 73, the possibility determiner 133 determines that the dirtiness of the interior can be purified by the equipment of the own vehicle M. When it is determined that the stain may not be removed by driving the seat cover actuators 72 or the mat actuator 73, the possibility determiner 133 determines that the dirtiness of the interior may not be purified by the equipment of the own vehicle M. In this example, the case in which the stain may not be removed by driving the seat cover actuators 72 or the mat actuator 73 is a case in which stain is attached to another position other than the rear surface seat SC1, the sitting surface seat SC2, or the mat MT.

The device controller 190 controls each unit included in the vehicle control device 1a according to a determination result of the possibility determiner 133. Specifically, when the possibility determiner 133 determines that the dirtiness of the interior can be purified by the equipment of the own vehicle M, the device controller 190 controls the purification device 70, the air conditioner 90, or the power window device 400 to purify the dirtiness of the interior.

### [Purification According to Action History Information 182]

The case in which the necessity determiner 132 determines that the purification of the interior is necessary when the predetermined conditions (1) to (4) are satisfied has been described above, but the present invention is not limited thereto. For example, when a condition that the own vehicle M travels (visits) to a place in which the purification of the interior is necessary (hereinafter referred to as a predetermined condition (5)) is satisfied, the necessity determiner 132 may determine that the purification of the interior is necessary. For example, when the own vehicle M travels to a place in which the purification of the interior is necessary, the necessity determiner 132 determines that the predetermined condition (5) is satisfied and determines that the purification of the interior is necessary, according to the action history information 182. The place in which the purification of the own vehicle M is necessary is a place in which it is estimated that the interior is polluted when the own vehicle visits the place. Specifically, the place in which it is estimated that the interior is polluted is a place in which there is a high possibility of contact with viruses of a hospital or the like or a place, such as sea, a mountain, or a park, in which there is a high possibility of dirtiness such as mud or sand being attached to the body of an occupant staying in the place.

When a place in which an occupant staying on the own vehicle M is a place in which purification of the own vehicle M is necessary, the necessity determiner 132 determines that the purification of the interior is necessary according to the action history information 182. For example, the device controller 190 controls the purification device 70 and causes the sprinkler 71 to spray the detergent within a predetermined time after the occupant gets out. The predetermined time is a time in which latent viruses proliferate (for example, immediately after the occupant gets out).

### Conclusion of Second Embodiment

As described above, in the vehicle control device 1a according to the embodiment, the necessity determiner 132 determines whether the purification of the own vehicle M is necessary further according to the action history information 182 indicating a history of movement of the own vehicle M and the device controller 190 causes the purification device 70 to spray the detergent within a predetermined time after an occupant gets out of the own vehicle M. Thus, when the vehicle travels and becomes dirty, the vehicle control device 1a according to the embodiment can purify the vehicle and sterilize the interior by the purification.

### [Purification According to Surrounding Environment of Own Vehicle M]

The case in which the necessity determiner 132 determines whether the purification of the interior is necessary according to a situation of the interior determined by the air sensor 45 or the interior camera 300 has been described above, but the present invention is not limited thereto. For example, the necessity determiner 132 may determine whether the purification of the interior is necessary according to the surrounding environment of the own vehicle M determined by the camera 10 or the air sensor 45 installed outside the own vehicle M.

For example, when rain is falling according to an image captured by the camera 10 (a predetermined condition (6)) or dust, pollen, or PM2.5 is determined by the air sensor 45 installed outside the own vehicle M (a predetermined condition (7)), it is estimated that the body of an occupant getting on the own vehicle from now becomes dirty, and thus the necessity determiner 132 may determine that the purification of the interior is necessary.

For example, when it is recognized that the body of the vehicle M becomes dirty according to an image captured by the camera 10 (a predetermined condition (8)), the necessity determiner 132 may determine that the purification of the own vehicle M is necessary. In this case, the possibility determiner 133 may determine whether the own vehicle M (a window or the vehicle itself) can be purified by equipment or the like (for example, a washer liquid injector) of the own vehicle M. When the possibility determiner 133 determines that the purification of the own vehicle M is possible, the device controller 190 controls the washer liquid injector and injects a washer liquid to the window of the own vehicle M or the own vehicle M itself to purify the own vehicle M. When the possibility determiner 133 determines that the own vehicle M may not be purified, the device controller 190 instructs the purification driving controller 141 to move the own vehicle M to a cleaning facility indicated by the cleaning facility information 181.

Thus, the vehicle control device 1a according to the embodiment can determine whether the purification of the own vehicle M is necessary further according to a surrounding environment of the own vehicle M to purify the own vehicle M.

### [Hardware Configuration]

FIG. 10 is a diagram showing an example of a hardware configuration of the automatic driving control device 100 according to the embodiment. As shown, the automatic driving control device 100 is configured such that a communication controller 100-1, a CPU 100-2, a RAM 100-3 that is used as a working memory, a ROM 100-4 that stores a boot program or the like, a storage device 100-5 such as a flash memory or an HDD, a drive device 100-6, and the like are connected to each other via an internal bus or a dedicated communication line. The communication controller 100-1 performs communication with constituent element other than the automatic driving control device 100. The storage device 100-5 stores a program 100-5a that is executed by the CPU 100-2. The program is loaded on the RAM 100-3 by a direct memory access (DMA) controller (not shown) to be executed by the CPU 100-2. Thus, one or both of the first controller 120 and the second controller 160 are realized.

The above-described embodiment can be expressed as follows.

A vehicle purification device includes a storage that stores a program and is configured to determine a state of a vehicle; determine whether purification of the vehicle is necessary according to the determined state of the vehicle; determine whether the purification of the vehicle is possible using equipment of the vehicle when the purification of the vehicle is determined to be necessary; and perform a predetermined operation so that the purification is performed by another unit different from the equipment of the vehicle when the purification of the vehicle is determined not to be possible.

While preferred embodiments of the invention have been described and shown above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A vehicle purification device comprising:
a determiner configured to determine a state of a vehicle;
a necessity determiner configured to determine whether purification of the vehicle is necessary according to the state of the vehicle determined by the determiner;
a possibility determiner configured to determine whether the purification of the vehicle is possible using equipment of the vehicle when the necessity determiner determines that the purification of the vehicle is necessary; and
a device controller configured to perform a predetermined operation so that the purification is performed by another unit different from the equipment of the vehicle when the possibility determiner determines that the purification of the vehicle is not possible.

2. The vehicle purification device according to claim 1,
wherein the predetermined operation is guidance to a cleaning place in which the purification of the vehicle is possible,
wherein the vehicle purification device further comprises:
a recognizer configured to recognize a surrounding situation of the vehicle; and
a driving controller configured to control one or both of steering and acceleration or deceleration of the vehicle according to a recognition result of the recognizer, and
wherein the device controller is configured to control the driving controller such that the vehicle travels to the cleaning place when the possibility determiner determines that the purification is not possible using the equipment.

3. The vehicle purification device according to claim 1,
wherein the determiner includes an imaging device, and
wherein the necessity determiner is configured to determine whether the purification of the vehicle is necessary according to an image captured by the imaging device.

4. The vehicle purification device according to claim 1,
wherein the necessity determiner is configured to determine whether the purification of the vehicle is necessary further according to action history information indicating a history of movement of the vehicle.

5. The vehicle purification device according to claim 1,
wherein the necessity determiner is configured to determine whether the purification of the vehicle is necessary further according to a surrounding environment of the vehicle.

6. The vehicle purification device according to claim 1,
wherein the equipment includes a spraying device that is configured to spray a detergent purifying an interior of the vehicle, and
wherein the predetermined operation is the spraying of the detergent by the spraying device.

7. The vehicle purification device according to claim 6,
wherein the device controller is configured to cause the spraying device to spray the detergent within a predetermined time after an occupant gets out of the vehicle.

8. A vehicle purification method of causing a computer to:
determine a state of a vehicle;
determine whether purification of the vehicle is necessary according to the determined state of the vehicle;
determine whether the purification of the vehicle is possible using equipment of the vehicle when the purification of the vehicle is determined to be necessary; and
perform a predetermined operation so that the purification is performed by another unit different from the equipment of the vehicle when the purification of the vehicle is determined not to be possible.

9. A storage medium causing a computer to:
determine a state of a vehicle;
determine whether purification of the vehicle is necessary according to the determined state of the vehicle;
determine whether the purification of the vehicle is possible using equipment of the vehicle when the purification of the vehicle is determined to be necessary; and
perform a predetermined operation so that the purification is performed by another unit different from the equipment of the vehicle when the purification of the vehicle is determined not to be possible.
